(19) United States
(12) Patent Application Publication
(10) Pub. No.: US 2026/0067882 A1
(43) Pub. Date: Mar. 5, 2026

(54) CAPABILITY INFORMATION REPORTING METHOD AND APPARATUS, AND DEVICE AND STORAGE MEDIUM

(71) Applicant: GUANGDONG OPPO MOBILE TELECOMMUNICATIONS CORP., LTD., Dongguan (CN)

(72) Inventor: Rui ZHOU, Dongguan (CN)

(21) Appl. No.: 19/382,445

(22) Filed: Nov. 7, 2025

Related U.S. Application Data
(63) Continuation of application No. PCT/CN2023/106830, filed on Jul. 11, 2023.

(51) Int. Cl. H04W 72/0453; H04W 72/541

(52) U.S. Cl. CPC H04W 72/0453; H04W 72/541

(57) ABSTRACT

A capability information reporting method includes: reporting first capability information to a network device, where the first capability information is used to indicate a frequency separation supported or expected by the terminal device.

### CROSS-REFERENCE TO RELATED APPLICATION

This application is a Continuation Application of International Application No. PCT/CN2023/106830 filed on Jul. 11, 2023, which is incorporated herein by reference in its entirety.

### RELATED ART

The present application relates to the field of communications, and to a capability information reporting method, capability information reporting apparatuses, devices, and a storage medium.

### BACKGROUND

The terminal device will cause non-negligible self-interference to its own reception during transmission, that is, uplink transmission and downlink transmission corresponding to the terminal device interfere with each other.

Therefore, how to avoid the interference between the uplink transmission and the downlink transmission is a problem that needs to be solved.

### SUMMARY

Embodiments of the present application provide a capability information reporting method, capability information reporting apparatuses, devices, and a non-transitory storage medium.

According to an aspect of the present application, a capability information reporting method is provided. The method is performed by a terminal device and includes:
reporting first capability information to a network device, where the first capability information is used to indicate a frequency separation supported or expected by the terminal device.

According to an aspect of the present application, a capability information reporting method is provided. The method is performed by a network device and includes:
receiving first capability information reported by a terminal device, where the first capability information is used to indicate a frequency separation supported or expected by the terminal device.

According to an aspect of the present application, a capability information reporting apparatus is provided, the apparatus includes:
a reporting module, configured to report first capability information to a network device, where the first capability information is used to indicate a frequency separation supported or expected by the apparatus.

According to an aspect of the present application, a capability information reporting apparatus is provided, the apparatus includes:
a second receiving module, configured to receive first capability information reported by a terminal device, where the first capability information is used to indicate a frequency separation supported or expected by the terminal device.

According to an aspect of the present application, a terminal device is provided, where the terminal device includes: a processor, a transceiver connected to the processor, and a memory for storing executable instructions of the processor; where the processor is configured to load and execute the executable instructions to enable the terminal device to implement the capability information reporting method as described in the above aspects.

According to an aspect of the present application, a network device is provided, where the network device includes: a processor, a transceiver connected to the processor, and a memory for storing executable instructions of the processor; where the processor is configured to load and execute the executable instructions to enable the network device to implement the capability information reporting method as described in the above aspects.

According to an aspect of the present application, a non-transitory computer-readable storage medium is provided, the non-transitory computer-readable storage medium stores executable instructions, and the executable instructions are loaded and executed by a processor to implement the capability information reporting method as described in the above aspects.

According to an aspect of the present application, a computer program product is provided, the computer program product includes computer instructions, the computer instructions are stored in a non-transitory computer-readable storage medium, a processor of a computer device reads the computer instructions from the non-transitory computer-readable storage medium, and executes the computer instructions to enable the computer device to perform the capability information reporting method as described in the above aspects.

According to an aspect of the present application, a chip is provided, the chip includes a programmable logic circuit and/or program instructions, and when the chip is operated, is configured to implement the capability information reporting method as described in the above aspects.

According to an aspect of the present application, a computer program is provided, the computer program includes computer instructions, and a processor of a computer device executes the computer instructions to enable the computer device to perform the capability information reporting method as described in the above aspects.

### BRIEF DESCRIPTION OF THE DRAWINGS

In order to more clearly illustrate the technical solutions in the embodiments of the present application, a brief description of the drawings required in the embodiments is provided below. Obviously, the drawings described below are only some embodiments of the present application. For those shilled in the art, other drawings may be obtained based on these drawings without any creative work.

FIG. 1 is a schematic diagram of a mobile communication system provided by some exemplary embodiments of the present application.

FIG. 2 is a schematic flowchart of a capability information reporting method provided by some exemplary embodiments of the present application.

FIG. 3 is a schematic flowchart of a capability information reporting method provided by some exemplary embodiments of the present application.

FIG. 4 is a schematic diagram of a frequency separation provided by some exemplary embodiments of the present application.

FIG. 5 is a schematic flowchart of a capability information reporting method provided by some exemplary embodiments of the present application.

FIG. 6 is a schematic flowchart of a capability information reporting method provided by some exemplary embodiments of the present application.

FIG. 7 is a schematic flowchart of a capability information reporting method provided by some exemplary embodiments of the present application.

FIG. 8 is a structural block diagram of a capability information reporting apparatus provided by some exemplary embodiments of the present application.

FIG. 9 is a structural block diagram of a capability information reporting apparatus provided by some exemplary embodiments of the present application.

FIG. 10 is a schematic structural diagram of a communication device provided by some exemplary embodiments of the present application.

### DETAILED DESCRIPTION

In order to make the objectives, technical solutions and advantages of the present application clearer, implementations of the present application will be further described in detail below with reference to the accompanying drawings. Exemplary embodiments will be described in detail, with examples illustrated in the accompanying drawings. When the following description refers to the drawings, unless otherwise indicated, the same reference numerals in different drawings represent the same or similar elements. The implementations described in the following exemplary embodiments do not represent all implementations consistent with the present application. Rather, they are merely examples of apparatus and methods consistent with some aspects of the present application as detailed in the appended claims.

The terms used here are intended solely for a purpose of describing embodiments only and are not intended to limit the scope of the present application. As used in the present application and the appended claims, the singular forms “a,” “an,” “said,” and “the” are intended to include the plural forms as well, unless the context clearly indicates otherwise. It should further be understood that the term “and/or” as used herein refers to and encompasses any and all possible combinations of one or more of the associated listed items.

It should be understood that, in the present application, although the terms “first,” “second,” “third,” or the like may be used to describe various information, such information should not be limited to these terms. These terms are used only to distinguish information of the same type from one another. For example, without departing from the scope of the present application, first information may be referred to as second information, and similarly, the second information may also be referred to as the first information. Depending on the context, the word “if” as used herein may be interpreted as “when” or “in a case where” or “in response to determining.”

First, the relevant technology involved in the embodiment of the present application is introduced:
an enhanced reduced capability (eRedcap) terminal is a lightweight terminal that achieves lower cost and complexity by reducing its own capabilities and power consumption. It has attracted widespread attention in the fields of industrial sensing, video surveillance, wearable devices, and logistics tracking.

Different eRedcap terminals may be categorized into two types, as shown in Table 1.

TABLE 1
eRedcap Terminal Types

| | First-type eRedCap | Second-type eRedCap |
|---|---|---|
| | terminal (20 MHz + | terminal (BW3/PR3 + |
| | PR1) | PR1) |
| UE RF channel | Up to 20 MHz | Up to 20 MHz |
| BW | | |
| Physical resource | No PRB restriction | For 15 kHz subcarrier spacing |
| block (PRB) | | (SCS), the maximum number |
| restriction | | of RBs is 25. For 30 kHz SCS, |
| | | the maximum number of RBs is |
| | | 12. |

| | |
|---|---|
| Peak data rate | Targeted to same peak data rate, i.e., probably |
| reduction | 10.67 Mbps |

Here, PRI represents Peak Rate 1, which means adapting the transmission rate by restricting the maximum rate. PR3 represents Peak Rate 3, which means adapting the transmission rate by restricting the number of resource blocks.

For the first-type eRedcap terminal, radio frequency indicators are consistent with those of the Redcap terminal in the related art.

For the second-type eRedcap terminal, processing capability in the baseband has been reduced, that is, it only supports at most 25 RBs in a case where the subcarrier spacing is 15 kHz, and only supports at most 12 RBs in a case where the subcarrier spacing is 30 kHz. However, in terms of RF channel BW, the maximum bandwidth supported is still 20 MHz.

In summary, in the RF design of the eRedcap terminal, it is still necessary to adopt 20 MHz bandwidth RF filtering related configuration. Consequently, RF filtering may not achieve separate filtering of 5 MHz.

However, the eRedcap terminal using the above design solution will cause non-negligible self-interference to its own reception during transmission, that is, the uplink transmission and downlink transmission corresponding to the eRedcap terminal interfere with each other.

According to the above problems, the present application provides a capability information reporting method, which supports the use of the flexible frequency separation to avoid interference between uplink transmission and downlink transmission as much as possible.

FIG. 1 is a schematic diagram of a mobile communication system provided by exemplary embodiments of the present application. The mobile communication system includes a network device 110 and a terminal device 120, and may include or exclude a terminal device 130, which is not limited in this application.

The network device 110 in the present application provides wireless communication functions, and the network device 110 includes but is not limited to: an evolved node B (eNB), a radio network controller (RNC), a node B (NB), a base station controller (BSC), a base transceiver station (BTS), a home base station (e.g., home evolved node B, or home node B, HNB), baseband unit (BBU), an access point (AP) in the wireless fidelity (Wi-Fi) system, a wireless relay node, a wireless backhaul node, a transmission point (TP) or a transmission and reception point (TRP), and may also be the next generation node B (gNB) or a TRP/TP in the 5th generation (5G) mobile communication system, or one antenna panel or a set of antenna panels (including multiple antenna panels) of a base station in the 5G system, or a network node constituting a gNB or transmission point, such as a baseband unit (BBU) or a distributed unit (DU), or a base station in a Beyond Fifth Generation (B5G) or the 6th Generation (6G) mobile communication system, or a core network (CN), fronthaul, backhaul, a radio access network (RAN), a network slice, or a serving cell, a primary cell (PCell), a primary secondary cell (PSCell), a special cell (SpCell), a secondary cell (SCell), or a neighboring cell of a terminal device.

The terminal device 120 in this application is also called user equipment (UE), an access terminal, a user unit, a user station, a mobile station, a mobile platform, a remote station, a remote terminal, a mobile device, a user terminal, a terminal, a wireless communication device, a user agent, and a user apparatus. The terminal includes, but is not limited to, a handheld device, a wearable device, a vehicle-mounted device, and an internet of things (IoT) device, such as a mobile phone, a tablet computer, an e-book reader, a laptop computer, a desktop computer, a television, a game console, a mobile internet device (MID), an augmented reality (AR) terminal, a virtual reality (VR) terminal, a mixed reality (MR) terminal, an extended reality (XR) terminal, a baffle reality (BR) terminal, a cinematic reality (CR) terminal, a deceive reality (DR) terminal, a wearable device, a handle, an electronic tag, a controller, a wireless terminal in industrial control, a wireless terminal in self-driving, a wireless terminal in remote medical care, a wireless terminal in the smart grid, a wireless terminal in the transportation safety, a wireless terminal in the smart city, a wireless terminal in the smart home, and a wireless terminal in the remote medical surgery, a cellular phone, a cordless phone, a session initiation protocol (SIP) phone, a wireless local loop (WLL) station, a personal digital assistant (PDA), a TV Set Top Box (STB), a customer premise equipment (CPE), a sensor, a monitoring device, etc.

The network device 110 and the terminal device 120 communicate with each other via some air interface technology, such as a Uu interface.

Exemplarily, there are two communication scenarios between the network device 110 and the terminal device 120: an uplink communication scenario and a downlink communication scenario. Here, uplink communication, or called uplink transmission, refers to transmitting a signal or data to the network device 110; and downlink communication, or called downlink transmission, refers to transmitting a signal or data to the terminal device 120.

The terminal device 120 and the terminal device 130 communicate with each other via some air interface technology, such as a Uu interface.

In some embodiments, there are two communication scenarios between the terminal device 120 and the terminal device 130: a first sidelink communication scenario and a second sidelink communication scenario. The first sidelink communication refers to transmitting a signal to the terminal device 130; and the second sidelink communication refers to transmitting a signal to the terminal device 120.

The terminal device 120 and the terminal device 130 are both within the network coverage and located in the same cell, or the terminal device 120 and the terminal device 130 are both within the network coverage but are located in different cells, or the terminal device 120 is within the network coverage, but the terminal device 130 is outside the network coverage.

The technical solutions provided in the embodiments of the present application may be applied to various communication systems, such as: a global system of mobile communication (GSM) system, a code division multiple access (CDMA) system, a wideband code division multiple access (WCDMA) system, a general packet radio service (GPRS), a long term evolution (LTE) system, a frequency division duplex (FDD) system, a time division duplex (TDD) system, an advanced long term evolution (LTE-A) system, a universal mobile telecommunication system (UMTS), a worldwide interoperability for microwave access (WiMAX) communication system, a 5G mobile communication system, a new radio (NR) system, an evolution system of the NR system, an LTE-based access to unlicensed spectrum (LTE-U) system, an NR-based access to unlicensed spectrum (NR-U) system, a terrestrial network (TN) system, a non-terrestrial network (NTN) system, a wireless local area network (WLAN), a Wi-Fi system, a cellular IoT system, and a cellular passive IoT system. It may also be applied to the subsequent evolution system of the 5G NR system, as well as B5G, 6G, and the subsequent evolution system. In some embodiments of the present application, “NR” may also be referred to as a 5G NR system or a 5G system. The 5G mobile communication system may include non-standalone networking (NSA) and/or standalone networking (SA).

The technical solutions provided in the embodiments of the present application may also be applied to machine type communication (MTC), the long term evolution-machine to machine (LTE-M) communication technology, a device to device (D2D) network, a machine to machine (M2M) network, an internet of things (IoT) network or other networks. The IoT network may include, for example, the internet of vehicles. The communication methods in the internet of vehicles system are collectively referred to as vehicle-to-x (V2X) communication (where X may represent anything). For example, V2X may include vehicle-to-vehicle (V2V) communication, vehicle-to-infrastructure (V2I) communication, vehicle-to-pedestrian (V2P) communication, and vehicle-to-network (V2N) communication.

The mobile communication system provided in the embodiment of the present application may be applied to but not limited to at least one of the following communication scenarios: an uplink communication scenario, a downlink communication scenario, or a sidelink communication scenario.

FIG. 2 is a schematic flowchart of a capability information reporting method provided by some exemplary embodiments of the present application. The method is schematically described by taking the terminal device illustrated in FIG. 1 as an example. The method includes at least some of the following operation:
in an operation 210: first capability information is reported to a network device, where the first capability information is used to indicate a frequency separation supported or expected by the terminal device.

The frequency separation refers to a separation between an uplink frequency corresponding to the terminal device and a downlink frequency corresponding to the terminal device. Alternatively, it may be understood that the frequency separation refers to a separation between an uplink operating frequency of the terminal device and a downlink operating frequency of the terminal device. The setting of the frequency separation may make strength of the self-interference signal of the terminal device as average as possible, reducing the interference between the uplink frequency and the downlink frequency.

In some embodiments, the frequency separation indicated by the first capability information is a minimum frequency separation between an uplink frequency and a downlink frequency, that is, the frequency separation indicated by the first capability information is a minimum frequency separation between an uplink operating frequency and a downlink operating frequency. That is to say, the frequency separation between the uplink frequency and the downlink frequency actually corresponding to the terminal device may be greater than or equal to the frequency separation indicated by the first capability information.

In some embodiments, the first capability information is used to indicate a frequency separation supported by the terminal device, which means that the terminal device has the capability to operate using the frequency separation.

In some embodiments, the first capability information is used to indicate a frequency separation expected by the terminal device, which means that the terminal device expects to operate using the frequency separation.

The terminal device operates using the frequency separation, which may be understood as the terminal device using the frequency separation to perform at least one of the following operations: signal reception, signal transmission, signal detection, signal monitoring, signal measurement, channel measurement, cell access, cell camping, cell handover, or the like.

In summary, with the method provided by the embodiments of the present application, the terminal device reporting the supported or expected frequency separation is supported, to reflect an actual decreasing sensitivity (De-Sense) situation and an actual transmission situation of the terminal device, thereby assisting the network device in subsequently scheduling more reasonable and more targeted operating frequencies for the terminal device, and thus ensuring transmission quality of uplink transmission and downlink transmission, and improving intra-system communication efficiency.

FIG. 3 is schematic a flowchart of a capability information reporting method provided by some exemplary embodiments of the present application. The method is schematically described by taking the terminal device illustrated in FIG. 1 as an example. The method includes at least some of the following operation:
in an operation 310: first capability information is reported to a network device, where the first capability information is used to indicate a frequency separation supported or expected by the terminal device;

The frequency separation refers to a separation between an uplink frequency corresponding to the terminal device and a downlink frequency corresponding to the terminal device. Alternatively, it may be understood that the frequency separation refers to a separation between an uplink operating frequency of the terminal device and a downlink operating frequency of the terminal device. The setting of the frequency separation may make strength of the self-interference signal of the terminal device as average as possible, reducing the interference between the uplink frequency and the downlink frequency.

In some embodiments, the frequency separation indicated by the first capability information is a minimum frequency separation between an uplink frequency and a downlink frequency, that is, the frequency separation indicated by the first capability information is a minimum frequency separation between an uplink operating frequency and a downlink operating frequency. That is to say, the frequency separation between the uplink frequency and the downlink frequency actually corresponding to the terminal device may be greater than or equal to the frequency separation indicated by the first capability information.

In some embodiments, the first capability information is used to indicate a frequency separation supported by the terminal device, which means that the terminal device has the capability to operate using the frequency separation.

In some embodiments, the first capability information is used to indicate a frequency separation expected by the terminal device, which means that the terminal device expects to operate using the frequency separation.

The terminal device operates using the frequency separation, which may be understood as the terminal device using the frequency separation to perform at least one of the following operations: signal reception, signal transmission, signal detection, signal monitoring, signal measurement, channel measurement, cell access, cell camping, cell handover, or the like.

In some embodiments, the first capability information includes: a value of at least one frequency separation; or the value of the at least one frequency separation and a de-sensitivity value corresponding to the at least one frequency separation.

Exemplarily, the first capability information includes a value of a frequency separation, where the value of the frequency separation is 20, indicating that the terminal device supports or expects to use a frequency separation greater than 20 MHz for transmission.

Exemplarily, the first capability information includes values of three frequency separations and de-sensitivity values corresponding to the three frequency separations. The values of the three frequency separations are 20, 40, and 60, respectively, which are used to indicate that the terminal device supports or expects to use one or more of following frequency separations for transmission: a frequency separation greater than 20 MHz, a frequency separation greater than 40 MHz, and a frequency separation greater than 60 MHz.

In some embodiments, the first capability information includes at least one frequency separation index, each frequency separation index is used to indicate a value of a frequency separation, or used to indicate a value of a frequency separation and a de-sensitivity value corresponding to the frequency separation.

Exemplarily, the communication protocol stipulates values of m frequency separations, or the network device configures the values of the m frequency separations, or the network device and the terminal device negotiate to determine the values of the m frequency separations. The values of the m frequency separations correspond to m frequency separation indexes respectively. The terminal device carries at least one frequency separation index via the first capability information, which is used to indicate a value of at least one frequency separation corresponding to the at least one frequency separation index, where m is a positive integer.

Exemplarily, the communication protocol stipulates values of m frequency separations and de-sensitivity values corresponding to the m frequency separations, or the network device configures the values of the m frequency separations and the de-sensitivity values corresponding to the m frequency separations, or the network device and the terminal device negotiate to determine the values of the m frequency separations and the de-sensitivity values corresponding to the m frequency separations. The values of the m frequency separations correspond one-to-one to the m frequency separation indexes, and each frequency separation has a respective de-sensitivity value. The terminal device carries at least one frequency separation index via the first capability information, which is used to indicate a value of at least one frequency separation corresponding to the at least one frequency separation index and a de-sensitivity value corresponding to the at least one frequency separation, where m is a positive integer.

In some embodiments, the first capability information includes a bitmap, where the bitmap has k bits in total, and each bit represents a value of a respective frequency separation. Values of the frequency separations supported or expected by the terminal device and values of the frequency separations not supported or expected by the terminal device are represented by different bit values in the bitmap.

Exemplarily, in a case where a value of a certain frequency separation in the bitmap corresponds to a first value, it indicates that the value of the frequency separation is supported or expected by the terminal device; and in a case where a value of a certain frequency separation in the bitmap corresponds to a second value, it indicates that the value of the frequency separation is not supported or expected by the terminal device. For example, the first value is 1 and the second value is 0. For another example, the first value is 0 and the second value is 1.

Exemplarily, the communication protocol stipulates values of k frequency separations, or the network device configures the values of the k frequency separations, or the network device and the terminal device negotiate to determine the values of the k frequency separations. The values of the k frequency separations correspond to k bits in the bitmap respectively. The terminal device indicates, through the bitmap carried in the first capability information, whether the values of the k frequency separations are frequency separations supported or expected by the terminal device, where k is a positive integer.

Exemplarily, the communication protocol stipulates values of k frequency separations and de-sensitivity values corresponding to the k frequency separations, or the network device configures the values of the k frequency separations and the de-sensitivity values corresponding to the k frequency separations, or the network device and the terminal device negotiate to determine the values of the k frequency separations and the de-sensitivity values corresponding to the k frequency separations. The values of the k frequency separations correspond to k bits in the bitmap, and each frequency separation has a respective de-sensitivity value. The terminal device indicates, through the bitmap carried in the first capability information, whether the values of the k frequency separations are frequency separations supported or expected by the terminal device, where k is a positive integer.

Exemplarily, the bitmap carried by the first capability information is 010001101, where the corresponding bit values of a value 1, a value 5, a value 6, and a value 8 in the bitmap are 1, indicating that frequency separations corresponding to the value 1, the value 5, the value 6, and the value 8 are frequency separations supported or expected by the terminal device. The corresponding bit values in the bitmap of other values is 0, indicating that frequency separation corresponding to the other values is not supported or expected by the terminal device.

In some embodiments, the value of the at least one frequency separation is determined based on at least one of the following:
a de-sensitivity capability of the terminal device;
a baseband processing capability of the terminal device;
an radio frequency capability of the terminal device;
a reception sensitivity indicator of the terminal device;
an uplink frequency configured by the network device; or
a downlink frequency configured by the network device.

The de-sensitivity capability of the terminal device refers to a de-sensitivity threshold and/or a de-sensitivity value supported by the terminal device. The baseband processing capability of the terminal device may be understood as the signal processing capability of the terminal device. The radio frequency capability of the terminal device may be understood as the signal receiving and transmitting capability of the terminal device. The reception sensitivity indicator (i.e., reference sensitivity, REFSENS) of the terminal device is determined by the communication protocol or configured by the network device. The uplink frequency configured for the network device indicates that the terminal device may perform uplink transmission with the network device at the uplink frequency. The downlink frequency configured by the network device indicates that the terminal device may perform downlink transmission with the network device at the downlink frequency.

In some embodiments, the value of the at least one frequency separation is greater than or equal to a first difference, and less than or equal to a second difference;
where the first difference is a difference between a minimum value of a downlink frequency configured by the network device and a maximum value of an uplink frequency configured by the network device, and the second difference is a difference between a maximum value of the downlink frequency configured by the network device and a minimum value of the uplink frequency configured by the network device.

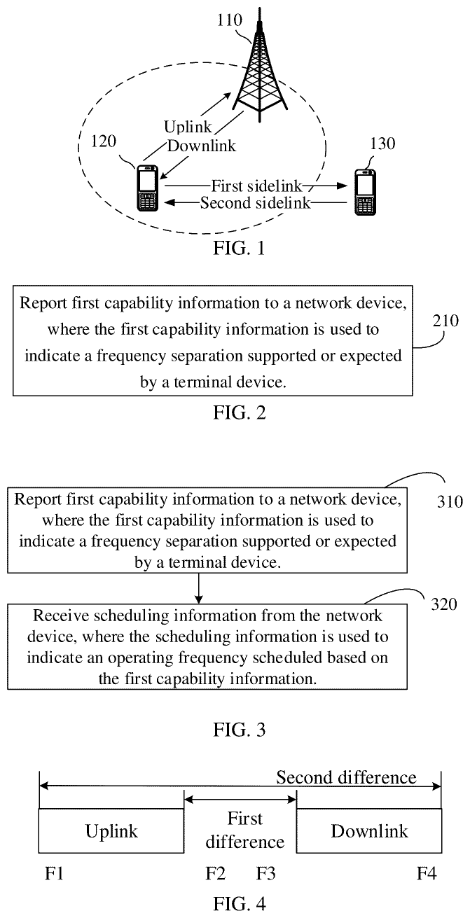

Exemplarily, as illustrated in FIG. 4, the uplink frequency configured by the network device ranges from F1 to F2, and the downlink frequency configured by the network device ranges from F3 to F4. Then, the first difference equals F3-F2, and the second difference equals F4-F1.

In some embodiments, the first capability information is transmitted in an uplink frequency configured by the network device.

In an operation 320: scheduling information from the network device is received, where the scheduling information is used to indicate an operating frequency scheduled based on the first capability information.

After receiving the first capability information, the network device schedules an operating frequency for the terminal device based on the first capability information. The terminal device transmits and/or receives a signal in the scheduled operating frequency.

In some embodiments, the scheduling information is transmitted in an operating frequency scheduled based on the first capability information. Alternatively, the terminal device receives the scheduling information from the network device in the operating frequency indicated by the scheduling information.

In some embodiments, the first capability information is carried in radio resource control (RRC) signaling, media access control control element (MAC CE), or downlink control information (DCI).

The RRC signaling includes RRC configuration signaling or RRC reconfiguration signaling.

It should be understood that in the embodiments of the present application, the operation 320 is an optional operation. The above operations may be used individually or in combination. The operation 310 may be implemented as a reporting method individually, the operation 320 may be implemented as a scheduling method individually, and the operations 310 and 320 may be combined to form a scheduling method.

In summary, with the method provided in the embodiment of the present application, the terminal device reporting the supported or expected frequency separation is supported, to reflect an actual de-sensitivity situation and an actual transmission situation of the terminal device, thereby assisting the network device in subsequently scheduling more reasonable and more targeted operating frequencies for the terminal device, and thus ensuring transmission quality of uplink transmission and downlink transmission, and improving intra-system communication efficiency. Furthermore, the network device schedules the operating frequency for the terminal device based on the first capability information, making the frequency scheduling more flexible. Compared with using a fixed frequency separation for uplink transmission and downlink transmission, the method provided in the embodiment of the present application is not only suitable for terminal devices with different capabilities, but also may flexibly schedule a reasonable operating frequency for the terminal device according to actual conditions, which avoids errors in the terminal device in the downlink coverage of the network, and will not cause the power consumption and cost of the terminal device to increase due to the strict frequency separation requirement.

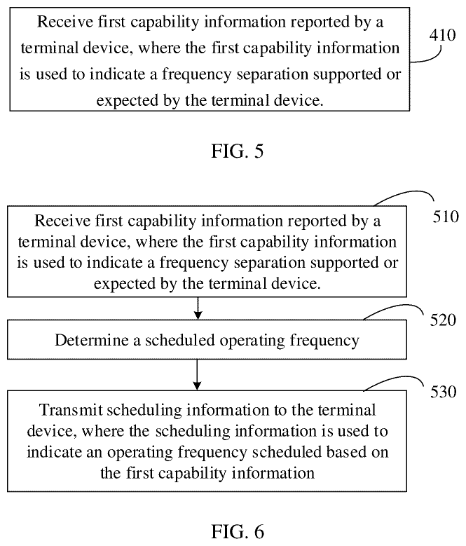

FIG. 5 is a schematic flowchart of a capability information reporting method provided by some exemplary embodiments of the present application. The method is schematically described by taking the network device illustrated in FIG. 1 as an example. The method includes at least some of the following operation:
in an operation 410: first capability information reported by a terminal device is received, where the first capability information is used to indicate a frequency separation supported or expected by the terminal device.

The frequency separation refers to a separation between an uplink frequency corresponding to the terminal device and a downlink frequency corresponding to the terminal device. Alternatively, it may be understood that the frequency separation refers to a separation between an uplink operating frequency and a downlink operating frequency of the terminal device. The setting of the frequency separation may make strength of the self-interference signal of the terminal device as average as possible, reducing the interference between the uplink frequency and the downlink frequency.

In some embodiments, the frequency separation indicated by the first capability information is a minimum frequency separation between an uplink frequency and a downlink frequency, that is, the frequency separation indicated by the first capability information is a minimum frequency separation between an uplink operating frequency and a downlink operating frequency. That is to say, the frequency separation between the uplink frequency and the downlink frequency actually corresponding to the terminal device may be greater than or equal to the frequency separation indicated by the first capability information.

The first capability information is used to indicate a frequency separation supported by the terminal device, which means that the terminal device has the capability to operate using the frequency separation.

The first capability information is used to indicate a frequency separation expected by the terminal device, which means that the terminal device expects to operate using the frequency separation.

The terminal device operates using the frequency separation, which may be understood as the terminal device using the frequency separation to perform at least one of the following operations: signal reception, signal transmission, signal detection, signal monitoring, signal measurement, channel measurement, cell access, cell camping, cell handover, or the like.

In summary, with the method provided by the embodiments of the present application, an actual de-sensitivity situation and an actual transmission situation of the terminal device are obtained by receiving the supported or expected frequency separation reported by the terminal device, thereby assisting the network device in subsequently scheduling more reasonable and more targeted operating frequencies for the terminal device, and thus ensuring transmission quality of uplink transmission and downlink transmission, and improving intra-system communication efficiency.

FIG. 6 is a schematic flowchart of a capability information reporting method provided by some exemplary embodiments of the present application. The method is schematically described by taking the terminal device illustrated in FIG. 1 as an example. The method includes at least some of the following operation:
in an operation 510: first capability information reported by a terminal device is received, where the first capability information is used to indicate a frequency separation supported or expected by the terminal device.

The frequency separation refers to a separation between an uplink frequency corresponding to the terminal device and a downlink frequency corresponding to the terminal device. Alternatively, it may be understood that the frequency separation refers to a separation between an uplink operating frequency and a downlink operating frequency of the terminal device. The setting of the frequency separation may make strength of the self-interference signal of the terminal device as average as possible, reducing the interference between the uplink frequency and the downlink frequency.

In some embodiments, the frequency separation indicated by the first capability information is a minimum frequency separation between an uplink frequency and a downlink frequency, that is, the frequency separation indicated by the first capability information is a minimum frequency separation between an uplink operating frequency and a downlink operating frequency. That is to say, the frequency separation between the uplink frequency and the downlink frequency actually corresponding to the terminal device may be greater than or equal to the frequency separation indicated by the first capability information.

The first capability information is used to indicate a frequency separation supported by the terminal device, which means that the terminal device has the capability to operate using the frequency separation.

The first capability information is used to indicate a frequency separation expected by the terminal device, which means that the terminal device expects to operate using the frequency separation.

The terminal device operates using the frequency separation, which may be understood as the terminal device using the frequency separation to perform at least one of the following operations: signal reception, signal transmission, signal detection, signal monitoring, signal measurement, channel measurement, cell access, cell camping, cell handover, or the like.

In some embodiments, the first capability information includes: a value of at least one frequency separation; or the value of the at least one frequency separation and a de-sensitivity value corresponding to the at least one frequency separation.

Exemplarily, the first capability information includes a value of frequency separation, where the value of the frequency separation is 20, indicating that the terminal device supports or expects to use a frequency separation greater than 20 MHz for transmission.

Exemplarily, the first capability information includes values of three frequency separations and de-sensitivity values corresponding to the three frequency separations. The values of the three frequency separations are 20, 40, and 60, respectively, which are used to indicate that the terminal device supports or expects to use one or more of following frequency separations for transmission: a frequency separations greater than 20 MHz, greater than 40 MHz, and greater than 60 MHz.

In some embodiments, the first capability information includes at least one frequency separation index, each frequency separation index is used to indicate a value of a frequency separation, or used to indicate a value of a frequency separation and a de-sensitivity value corresponding to the frequency separation.

Exemplarily, the communication protocol stipulates values of m frequency separations, or the network device configures the values of the m frequency separations, or the network device and the terminal device negotiate to determine the values of the m frequency separations. The values of the m frequency separations correspond to m frequency separation indexes respectively. The terminal device carries at least one frequency separation index via the first capability information, which is used to indicate a value of at least one frequency separation corresponding to the at least one frequency separation index, where m is a positive integer.

Exemplarily, the communication protocol stipulates values of m frequency separations and de-sensitivity values corresponding to the m frequency separations, or the network device configures the values of the m frequency separations and the de-sensitivity values corresponding to the m frequency separations, or the network device and the terminal device negotiate to determine the values of the m frequency separations and the de-sensitivity values corresponding to the m frequency separations. The values of the m frequency separations correspond one-to-one to the m frequency separation indexes, and each frequency separation has a respective de-sensitivity value. The terminal device carries at least one frequency separation index via the first capability information, which is used to indicate a value of at least one frequency separation corresponding to the at least one frequency separation index and a de-sensitivity value corresponding to the at least one frequency separation, where m is a positive integer.

In some embodiments, the first capability information includes a bitmap, where the bitmap has k bits in total, and each bit represents a value of a respective frequency separation. Values of the frequency separations supported or expected by the terminal device and values of the frequency separations not supported or expected by the terminal device are represented by different bit values in the bitmap.

Exemplarily, in a case where a value of a certain frequency separation in the bitmap corresponds to a first value, it indicates that the value of the frequency separation is supported or expected by the terminal device; and in a case where a value of a certain frequency separation in the bitmap corresponds to a second value, it indicates that the value of the frequency separation is not supported or expected by the terminal device. For example, the first value is 1 and the second value is 0. For another example, the first value is 0 and the second value is 1.

Exemplarily, the communication protocol stipulates values of k frequency separations, or the network device configures the values of the k frequency separations, or the network device and the terminal device negotiate to determine the values of the k frequency separations. The values of the k frequency separations correspond to k bits in the bitmap respectively. The terminal device indicates, through the bitmap carried in the first capability information, whether the values of the k frequency separations are frequency separations supported or expected by the terminal device, where k is a positive integer.

Exemplarily, the communication protocol stipulates values of k frequency separations and de-sensitivity values corresponding to the k frequency separations, or the network device configures the values of k frequency separations and the de-sensitivity values corresponding to the k frequency separations, or the network device and the terminal device negotiate to determine the values of the k frequency separations and the de-sensitivity values corresponding to the k frequency separations. The values of the k frequency separations correspond to k bits in the bitmap, and each frequency separation has a respective de-sensitivity value. The terminal device indicates, through the bitmap carried in the first capability information, whether the values of the k frequency separations are frequency separations supported or expected by the terminal device, where k is a positive integer.

Exemplarily, the bitmap carried by the first capability information is 010001101, where the corresponding bit values of a value 1, a value 5, a value 6, and a value 8 in the bitmap are 1, indicating that frequency separations corresponding to the value 1, the value 5, the value 6, and the value 8 are frequency separations supported or expected by the terminal device. The corresponding bit values in the bitmap of other values is 0, indicating that the frequency separation corresponding to the other values is not supported or expected by the terminal device.

In some embodiments, the value of the at least one frequency separation is determined based on at least one of the following:
a de-sensitivity capability of the terminal device;
a baseband processing capability of the terminal device;
an radio frequency capability of the terminal device;
a reception sensitivity indicator of the terminal device;
an uplink frequency configured by the network device; or
a downlink frequency configured by the network device.

The de-sensitivity capability of the terminal device refers to a de-sensitivity threshold and/or a de-sensitivity value supported by the terminal device. The baseband processing capability of the terminal device may be understood as the signal processing capability of the terminal device. The radio frequency capability of the terminal device may be understood as the signal receiving and transmitting capability of the terminal device. The reception sensitivity indicator of the terminal device is determined by the communication protocol or configured by the network device. The uplink frequency configured for the network device indicates that the terminal device may perform uplink transmission with the network device at the uplink frequency. The downlink frequency configured by the network device indicates that the terminal device may perform downlink transmission with the network device at the downlink frequency.

In some embodiments, the value of the at least one frequency separation is greater than or equal to the first difference, and less than or equal to the second difference;
where the first difference is a difference between a minimum value of a downlink frequency configured by the network device and a maximum value of an uplink frequency configured by the network device, and the second difference is a difference between a maximum value of the downlink frequency configured by the network device and a minimum value of the uplink frequency configured by the network device.

Exemplarily, as illustrated in FIG. 4, the uplink frequency configured by the network device ranges from F1 to F2, and the downlink frequency configured by the network device ranges from F3 to F4. Then, the first difference equals F3−F2, and the second difference equals F4−F1.

In some embodiments, the first capability information is transmitted in an uplink frequency configured by the network device.

In an operation 520: a scheduled operating frequency is determined.

In some embodiments, the scheduled operating frequency is determined based on the first capability information; or
the operating frequency is determined based on the first capability information and channel quality; or
the operating frequency is determined based on the first capability information and a communication requirement of the network device; or
the operating frequency is determined based on the first capability information, the channel quality, and the communication requirement of the network device.

The channel quality is channel quality corresponding to a channel between the network device and the terminal device, and the channel quality may be represented by at least one of the following: a reference signal receiving power (RSRP) value, a reference signal strength indicator (RSSI) value, a reference signal receiving quality (RSRQ) value, a signal to interference plus noise ratio (SINR) value, a cross link interference (CLI) value, a channel state information (CSI) value, or etc.

The communication requirement of the network device may also be understood as the business requirement of the network device.

In an operation 530: scheduling information is transmitted to the terminal device, where the scheduling information is used to indicate an operating frequency scheduled based on the first capability information.

After receiving the first capability information, the network device schedules an operating frequency for the terminal device based on the first capability information. The terminal device transmits and/or receives a signal in the scheduled operating frequency.

In some embodiments, the scheduling information is transmitted in an operating frequency scheduled based on the first capability information. Alternatively, the terminal device receives the scheduling information from the network device in the operating frequency indicated by the scheduling information.

In some embodiments, the first capability information is carried in RRC signaling, or MAC CE, or DCI.

The RRC signaling includes RRC configuration signaling or RRC reconfiguration signaling.

It should be understood that in the embodiments of the present application, the operation 520 and the operation 530 are optional operations. The above operations may be used individually or in combination. The operation 510 and the operation 530 may be combined to form a scheduling method. The operation 530 may be implemented as a scheduling method individually. The operation 520 and the operation 530 may be combined to be implemented as a scheduling method.

In summary, with the method provided by the embodiments of the present application, an actual de-sensitivity situation and an actual transmission situation of the terminal device is obtained by receiving the supported or expected frequency separation reported by the terminal device. Based on this, more reasonable and more targeted operating frequencies are scheduled for the terminal device to ensure transmission quality of uplink transmission and downlink transmission and improve intra-system communication efficiency. Furthermore, the network device schedules the operating frequency for the terminal device based on the first capability information, making frequency scheduling more flexible. Compared with using a fixed frequency separation for uplink transmission and downlink transmission, the method provided in the embodiment of the present application is not only suitable for terminal devices with different capabilities, but also may flexibly schedule a reasonable operating frequency for the terminal device according to actual conditions, which avoids errors in the terminal device in the downlink coverage of the network, and will not cause the power consumption and cost of the terminal device to increase due to the strict frequency separation requirement.

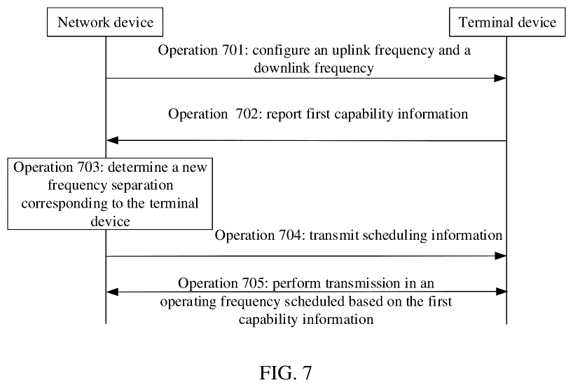

FIG. 7 is a schematic flowchart of a capability information reporting method provided by some exemplary embodiments of the present application. The method is schematically described by taking the terminal device and the network device illustrated in FIG. 1 as an example. The method includes at least some of the following operation:
in an operation 701: the network device configures an uplink frequency and a downlink frequency for the terminal device; and the network device determines the uplink frequency and downlink frequency configured for the terminal device, and transmits the configuration to the terminal device.

In some embodiments, the configuration of the uplink frequency and the downlink frequency is carried in RRC signaling. Alternatively, it may be understood that the network device configures the uplink frequency and downlink frequency to the terminal device through the RRC configuration.

In some embodiments, the configuration of the uplink frequency is implemented based on a parameter Frequency InfoUL, and the configuration of the downlink frequency is implemented based on a parameter Frequency InfoDL.

In an operation 702: the terminal device reports the first capability information;
the terminal device reports the first capability information in the uplink frequency configured by the network device, where the first capability information is used to indicate a frequency separation supported or expected by the terminal device.

In some embodiments, the first capability information includes: a value of at least one frequency separation; or the value of the at least one frequency separation and a de-sensitivity value corresponding to the at least one frequency separation.

Exemplarily, the first capability information includes one or more values of frequency separations, such as at least one of 20 MHz, 30 MHz, 40 MHz, 50 MHz, 60 MHz, or 70 MHz.

Exemplarily, the first capability information includes one or more sets of values, and each set of values includes a value of a frequency separation and a de-sensitivity value corresponding to the frequency separation. As illustrated in Table 2, it means that a frequency separation of 20 MHz corresponds to a 0.2 decibels (dB) de-sensitivity, and/or a frequency separation of 40 MHz corresponds to a 0.3 dB de-sensitivity, and/or a frequency separation of 70 MHz corresponds to a 0.6 dB de-sensitivity. It should be noted that each row of data in Table 2 can be used individually, for example, the first capability information only includes a set of values corresponding to any one row; any two rows of data in Table 2 may be used in combination, for example, the first capability information includes two sets of values corresponding to any two rows; and three rows of data in Table 3 may be used in combination, for example, the first capability information includes three sets of values corresponding to three rows.

TABLE 2
One or more sets of values included
in the first capability information

| Reception frequency separation | |
|---|---|
| (TxRxSeperationREF)/MHz | De-sensitivity (De-sense)/dB |
| 20 | 0.2 |
| 40 | 0.3 |
| 70 | 0.6 |

In some embodiments, the value of the at least one frequency separation is determined based on at least one of the following:
a de-sensitivity capability of the terminal device;
a baseband processing capability of the terminal device;
an radio frequency capability of the terminal device;
a reception sensitivity indicator of the terminal device;
an uplink frequency configured by the network device; or
a downlink frequency configured by the network device.

The de-sensitivity capability of the terminal device refers to a de-sensitivity threshold and/or a de-sensitivity value supported by the terminal device. The baseband processing capability of the terminal device may be understood as the signal processing capability of the terminal device. The radio frequency capability of the terminal device may be understood as the signal receiving and transmitting capability of the terminal device. The reception sensitivity indicator of the terminal device is determined by the communication protocol or configured by the network device. The uplink frequency configured for the network device indicates that the terminal device may perform uplink transmission with the network device at the uplink frequency. The downlink frequency configured by the network device indicates that the terminal device may perform downlink transmission with the network device at the downlink frequency.

In some embodiments, the value of the at least one frequency separation is greater than or equal to the first difference, and less than or equal to the second difference,
where the first difference is a difference between a minimum value of a downlink frequency configured by the network device and a maximum value of an uplink frequency configured by the network device, and the second difference is a difference between a maximum value of the downlink frequency configured by the network device and a minimum value of the uplink frequency configured by the network device.

Exemplarily, as illustrated in FIG. 4, the uplink frequency configured by the network device ranges from F1 to F2, and the downlink frequency configured by the network device ranges from F3 to F4. Then, the first difference equals F3−F2, and the second difference equals F4−F1. The value of the at least one frequency separation is greater than or equal to F3−F2, and less than or equal to F4−F1.

In some embodiments, the first capability information includes a parameter TxRxSeperationREF, which is used to indicate a frequency separation capability supported or expected by the terminal device.

In some embodiments, the frequency separation indicated by the first capability information is a minimum frequency separation between an uplink frequency and a downlink frequency, that is, the frequency separation indicated by the first capability information is a minimum frequency separation between an uplink operating frequency and a downlink operating frequency. That is to say, the frequency separation between the uplink frequency and the downlink frequency actually corresponding to the terminal device may be greater than or equal to the frequency separation indicated by the first capability information.

In an operation 703: the network device determines a new frequency separation corresponding to the terminal device;

the network device determines the configured frequency separation based on the configured uplink frequency and the configured downlink frequency.

Exemplarily, the uplink frequency is a frequency indicated by the parameter FrequencyInfoUL, and the downlink frequency is a frequency indicated by the parameter FrequencyInfoDL. Then, the configured frequency separation F_gap=FrequencyInfoDL−Frequency InfoUL.

In some embodiments, the first capability information includes a value of at least one frequency separation. The network device determines a new frequency separation based on at least one of: a value included in the first capability information, a channel quality, or a communication requirement. Furthermore, the new frequency separation is smaller than the configured frequency separation F_gap.

The channel quality is channel quality corresponding to a channel between the network device and the terminal device. The channel quality may be represented by at least one of: the following: an RSRP value, an RSSI value, an RSRQ value, an SINR value, a CLI value, a CSI value, or etc.

In some embodiments, the first capability information includes a value of at least one frequency separation and a de-sensitivity value corresponding to the at least one frequency separation. The network device determines a new frequency separation based on at least one of: a value included in the first capability information, a channel quality, or a communication requirement. Furthermore, the new frequency separation is smaller than the configured frequency separation F_gap.

Exemplarily, the first capability information includes three sets of values shown in Table 2. The network device determines that de-sensitivity of 0.3 dB is acceptable based on the current channel quality, and determines 40 MHz as the new frequency separation, which means that the frequency separation between the uplink operating frequency and the downlink operating frequency that the network device is to schedule for the terminal device is greater than or equal to 40 MHz.

The network device determines the operating frequency scheduled for the terminal device based on the new frequency separation, where the operating frequency includes an uplink operating frequency and/or a downlink operating frequency.

In some embodiments, the operating frequency includes an uplink operating frequency, and a frequency separation between the uplink operating frequency and the downlink frequency configured in the operation 701 is greater than or equal to the new frequency separation. Exemplarily, a frequency separation between the uplink operating frequency and the downlink frequency configured in the operation 701 is greater than or equal to 40 MHz.

In some embodiments, the operating frequency includes a downlink operating frequency, and a frequency separation between the downlink operating frequency and the uplink frequency configured in the operation 701 is greater than or equal to the new frequency separation. Exemplarily, a frequency separation between the downlink operating frequency and the uplink frequency configured in the operation 701 is greater than or equal to 40 MHz.

In some embodiments, the operating frequency includes an uplink operating frequency and a downlink operating frequency, and a frequency separation between the uplink operating frequency and the downlink operating frequency is greater than or equal to the new frequency separation. Exemplarily, the frequency separation between the uplink operating frequency and the downlink operating frequency is greater than or equal to 40 MHz.

In an operation 704: the network device transmits scheduling information to the terminal device, where the scheduling information is used to indicate an operating frequency scheduled based on the first capability information.

After receiving the first capability information, the network device schedules an operating frequency for the terminal device based on the first capability information. The terminal device transmits and/or receives a signal in the scheduled operating frequency.

In some embodiments, the scheduling information is transmitted in an operating frequency scheduled based on the first capability information. Alternatively, the terminal device receives the scheduling information from the network device in the operating frequency indicated by the scheduling information.

In an operation 705: the network device and the terminal device perform transmission in an operating frequency scheduled based on the first capability information.

That is, the network device and the terminal device transmit in the operating frequency scheduled based on the first capability information.

It should be understood that in the embodiment of the present application, the operation 701, the operation 703, the operation 704, and the operation 705 are optional operations. The above operations may be used individually or in combination. The operation 701 and the operation 702 may be combined to be implemented as a configuration method, the operation 704 may be implemented individually as a scheduling method, the operation 703 and the operation 704 may be combined to be implemented as a scheduling method, the operation 705 may be implemented individually as a transmission method, the operation 701 and the operation 702 and the operation 705 may be combined to be implemented as a transmission method, and the operation 704 and the operation 705 may be combined to be implemented as a scheduling method or a transmission method.

In summary, with the method provided by the embodiments of the present application, the network device receives the supported or expected frequency separation reported by the terminal device to obtain an actual de-sensitivity situation and an actual transmission situation of the terminal device. Based on this, the network device schedules a more reasonable and targeted operating frequency for the terminal device to ensure transmission quality of uplink transmission and downlink transmission and improve intra-system communication efficiency. Furthermore, the network device schedules the operating frequency for the terminal device based on the first capability information, making frequency scheduling more flexible and performing corresponding configuration based on the actual operating frequency of the terminal device to ensure downlink coverage and downlink transmission performance of the network. Compared with using a fixed frequency separation for uplink transmission and downlink transmission, the method provided in the embodiment of the present application is not only suitable for terminal devices with different capabilities, but also may flexibly schedule a reasonable operating frequency for the terminal device according to actual conditions, which avoids errors in the terminal device in the downlink coverage of the network, and will not cause the power consumption and cost of the terminal device to increase due to the strict frequency separation requirement.

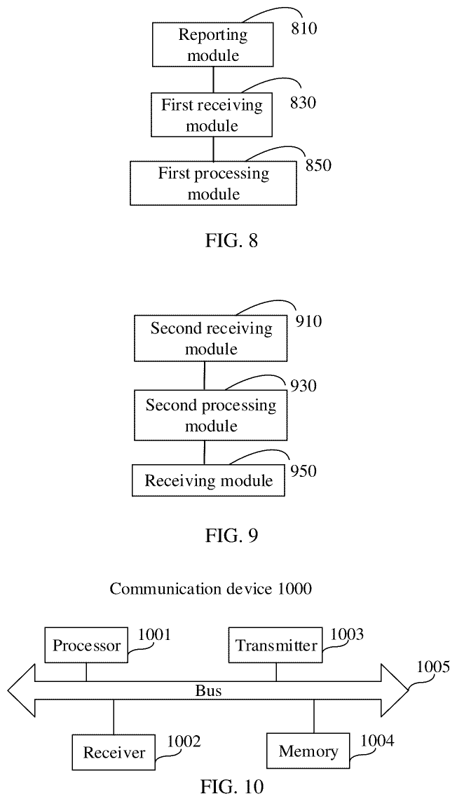

FIG. 8 is a structural block diagram of a capability information reporting apparatus provided by some exemplary embodiments of the present application. The apparatus includes at least some of the following modules: a reporting module 810, a first receiving module 830, or a first processing module 850.

The reporting module 810 is configured to report first capability information to a network device, where the first capability information is used to indicate a frequency separation supported or expected by the apparatus.

In some embodiments, the first capability information includes: a value of at least one frequency separation; or the value of the at least one frequency separation and a de-sensitivity value corresponding to the at least one frequency separation.

In some embodiments, the value of the at least one frequency separation is determined based on at least one of:
a de-sensitivity capability of the apparatus;
a baseband processing capability of the apparatus;
an radio frequency capability of the apparatus;
an uplink frequency configured by the network device; or
a downlink frequency configured by the network device.

In some embodiments, the value of the at least one frequency separation is greater than or equal to a first difference, and less than or equal to a second difference,
where the first difference is a difference between a minimum value of a downlink frequency configured by the network device and a maximum value of an uplink frequency configured by the network device; and the second difference is a difference between a maximum value of the downlink frequency configured by the network device and a minimum value of the uplink frequency configured by the network device.

In some embodiments, the first capability information is transmitted in an uplink frequency configured by the network device.

In some embodiments, the reporting module 810 is configured to transmit the first capability information in an uplink frequency configured by the network device.

In some embodiments, the apparatus further includes a first receiving module 830, configured to receive scheduling information from the network device, where the scheduling information is used to indicate an operating frequency scheduled based on the first capability information.

In some embodiments, the apparatus further includes a first processing module 850, configured to determine a value of at least one frequency separation; or, configured to determine the value of the at least one frequency separation and a de-sensitivity value corresponding to the at least one frequency separation.

In summary, the apparatus provided in the embodiment of the present application reports its own supported or expected frequency separation to reflect its actual decreasing sensitivity (De-Sense) situation and its actual transmission situation, thereby assisting the network device in subsequently scheduling more reasonable and more targeted operation frequencies for the apparatus, and thus ensuring the transmission quality of uplink transmission and downlink transmission, and improving the intra-system communication efficiency.

FIG. 9 is a structural block diagram of a capability information reporting apparatus provided by some exemplary embodiments of the present application. The apparatus includes at least some of the following modules: a second receiving module 910, a second processing module 930, or a transmitting module 950:

The second receiving module 910 is configured to receive first capability information reported by a terminal device, where the first capability information is used to indicate a frequency separation supported or expected by the terminal device.

In some embodiments, the first capability information includes: a value of at least one frequency separation; or the value of the at least one frequency separation and a de-sensitivity value corresponding to the at least one frequency separation.

In some embodiments, the value of the at least one frequency separation is determined based on at least one of the following:
a de-sensitivity capability of the terminal device;
a baseband processing capability of the terminal device;
an radio frequency capability of the terminal device;
an uplink frequency configured by the apparatus; or
a downlink frequency configured by the apparatus.

In some embodiments, the value of the at least one frequency separation is greater than or equal to a first difference, and less than or equal to a second difference,
where the first difference is a difference between a minimum value of a downlink frequency configured by the network device and a maximum value of an uplink frequency configured by the network device; and the second difference is a difference between a maximum value of the downlink frequency configured by the network device and a minimum value of the uplink frequency configured by the network device.

In some embodiments, the apparatus further includes a transmitting module 950, configured to transmit scheduling information to the terminal device, where the scheduling information is used to indicate an operating frequency scheduled based on the first capability information.

In some embodiments, the apparatus further includes a second processing module 930, configured to determine the operating frequency based on the first capability information; or, determine the operating frequency based on the first capability information and channel quality; or, determine the operating frequency based on the first capability information and a communication requirement of the network device; or, determine the operating frequency based on the first capability information, the channel quality, and the communication requirement of the network device,
where the channel quality is channel quality corresponding to a channel between the network device and the terminal device.

In some embodiments, the scheduling information is transmitted in the operating frequency.

In some embodiments, the transmitting module 950 is further configured to transmit the scheduling information in the operating frequency.

In some embodiments, the first capability information is transmitted in an uplink frequency configured by the network device.

In summary, with the apparatus provided in the embodiment of the present application, an actual de-sensitivity situation and an actual transmission situation of the terminal device are obtained by receiving the supported or expected frequency separation reported by the terminal device, thereby assisting the apparatus in subsequently scheduling more reasonable and more targeted operating frequencies for the terminal device, and thus ensuring transmission quality of uplink transmission and downlink transmission, and improving intra-system communication efficiency.

It should be noted that the apparatus provided in the above embodiments is only illustrated by the division of the above functional modules. In practical applications, the above functions may be assigned to different functional modules as required, that is, the internal structure of the device may be divided into different functional modules to complete all or part of the functions described above.

Regarding the apparatus in the embodiment, the manner in which each module performs operations has been described in detail in the embodiment of the method and will not be elaborated here.

FIG. 10 is a schematic structural diagram of a communication device (terminal device or network device) provided in some exemplary embodiments of the present application. The communication device 1000 includes: a processor 1001, a receiver 1002, a transmitter 1003, a memory 1004 and a bus 1005.

The processor 1001 includes one or more processing cores. The processor 1001 executes various functional applications and information processing by running software programs and modules. In some embodiments, the processor 1001 may be configured to implement the functions and operations of the first processing module 850 and/or the second processing module 930 described above.

The receiver 1002 and the transmitter 1003 may be implemented as a communication component, which may be a communication chip. In some embodiments, the receiver 1002 may be configured to implement the functions and operations of the first receiving module 830 and/or the second receiving module 910 as described above. In some embodiments, the transmitter 1003 may be used to implement the functions and operations of the reporting module 810 and/or the transmitting module 950 as described above.

The memory 1004 is connected to the processor 1001 via a bus 1005. The memory 1004 may be used to store at least one instruction, and the processor 1001 may be used to execute the at least one instruction to implement various operations in the above method embodiment.

In addition, the memory 1004 may be implemented by any type of volatile or non-volatile storage device or a combination thereof. The volatile or non-volatile storage device includes but is not limited to: a magnetic disk or an optical disk, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

In some embodiments, the receiver 1002 receives signals/data independently, or the processor 1001 controls the receiver 1002 to receive signals/data, or the processor 1001 requests the receiver 1002 to receive signals/data, or the processor 1001 cooperates with the receiver 1002 to receive signals/data.

In some embodiments, the transmitter 1003 independently transmits signals/data, or the processor 1001 controls the transmitter 1003 to transmit signals/data, or the processor 1001 requests the transmitter 1003 to transmit signals/data, or the processor 1001 cooperates with the transmitter 1003 to transmit signals/data.

In an exemplary embodiment of the present application, there is provided a non-transitory computer-readable storage medium, in which at least one program is stored. The at least one program is loaded and executed by the processor to implement the capability information reporting method provided by the above-mentioned various method embodiments.

In an exemplary embodiment of the present application, there is provided a chip, which includes a programmable logic circuit and/or program instructions that, when the chip runs on a communication device, are configured to implement the capability information reporting method provided by the above-mentioned various method embodiments.

In an exemplary embodiment of the present application, there is provided a computer program product that, when running on a processor of a computer device, enables the computer device to implement the above-mentioned capability information reporting method.

In an exemplary embodiment of the present application, there is provided a computer program including computer instructions that, when executed by a processor of a computer, enables the computer device to implement the above-mentioned capability information reporting method.

Those skilled in the art should appreciate that in one or more of the above examples, the functions described in the embodiments of the present application may be implemented in hardware, software, firmware or any combination thereof. When implemented in software, the functions may be stored in a non-transitory computer-readable medium, or transmitted as one or more instructions or codes on a non-transitory computer-readable medium. The non-transitory computer-readable medium includes both the non-transitory computer storage medium and the non-transitory communication medium, the non-transitory communication medium includes any non-transitory medium that facilitates transfer of the computer program from one place to another. The non-transitory storage medium may be any available non-transitory medium that may be accessed by a general purpose computer or a special purpose computer.

The above descriptions are merely optional embodiments of the present application and are not intended to limit the present application. Any modification, equivalent replacement, improvement, etc. made within the spirit and principle of the present application shall be included within the scope of protection of the present application.

What is claimed is:

1. A capability information reporting method, performed by a terminal device and comprising:
reporting first capability information to a network device, wherein the first capability information is used to indicate a frequency separation supported or expected by the terminal device.

2. The method according to claim 1, wherein the first capability information comprises:
a value of at least one frequency separation; or
the value of the at least one frequency separation, and a de-sensitivity value corresponding to the at least one frequency separation.

3. The method according to claim 2, wherein the value of the at least one frequency separation is determined based on at least one of:
a de-sensitivity capability of the terminal device;
a baseband processing capability of the terminal device;
an radio frequency capability of the terminal device;
an uplink frequency configured by the network device; or
a downlink frequency configured by the network device.

4. The method according to claim 2, wherein the value of the at least one frequency separation is greater than or equal to a first difference, and less than or equal to a second difference;
wherein the first difference is a difference between a minimum value of a downlink frequency configured by the network device and a maximum value of an uplink frequency configured by the network device; and the second difference is a difference between a maximum value of the downlink frequency configured by the network device and a minimum value of the uplink frequency configured by the network device.

5. The method according to claim 1, wherein the first capability information is transmitted in an uplink frequency configured by the network device.

6. The method according to claim 1, further comprising:
receiving scheduling information from the network device, wherein the scheduling information is used to indicate an operating frequency scheduled based on the first capability information.

7. A terminal device, comprising:
a processor, a transceiver connected to the processor, and a memory for storing executable instructions of the processor;
wherein the processor is configured to load and execute the executable instructions to cause the terminal device to perform:
reporting first capability information to a network device, wherein the first capability information is used to indicate a frequency separation supported or expected by the terminal device.

8. The terminal device according to claim 7, wherein the first capability information comprises:
a value of at least one frequency separation; or
the value of the at least one frequency separation, and a de-sensitivity value corresponding to the at least one frequency separation.

9. The terminal device according to claim 8, wherein the value of the at least one frequency separation is determined based on at least one of:
a de-sensitivity capability of the terminal device;
a baseband processing capability of the terminal device;
an radio frequency capability of the terminal device;
an uplink frequency configured by the network device; or
a downlink frequency configured by the network device.

10. The terminal device according to claim 8, wherein the value of the at least one frequency separation is greater than or equal to a first difference, and less than or equal to a second difference;
wherein the first difference is a difference between a minimum value of a downlink frequency configured by the network device and a maximum value of an uplink frequency configured by the network device; and the second difference is a difference between a maximum value of the downlink frequency configured by the network device and a minimum value of the uplink frequency configured by the network device.

11. The terminal device according to claim 7, wherein the first capability information is transmitted in an uplink frequency configured by the network device.

12. The terminal device according to claim 7, wherein the processor is configured to execute the executable instructions to cause the terminal device to further perform:
receiving scheduling information from the network device, wherein the scheduling information is used to indicate an operating frequency scheduled based on the first capability information.

13. A network device, comprising:
a processor, a transceiver connected to the processor, and a memory for storing executable instructions of the processor,
wherein the processor is configured to load and execute the executable instructions to cause the network device to perform:
receiving first capability information reported by a terminal device, wherein the first capability information is used to indicate a frequency separation supported or expected by the terminal device.

14. The network device according to claim 13, wherein the first capability information comprises:
a value of at least one frequency separation; or
the value of the at least one frequency separation, and a de-sensitivity value corresponding to the at least one frequency separation.

15. The network device according to claim 14, wherein the value of the at least one frequency separation is determined based on at least one of:
a de-sensitivity capability of the terminal device;
a baseband processing capability of the terminal device;
an radio frequency capability of the terminal device;
an uplink frequency configured by the network device; or
a downlink frequency configured by the network device.

16. The network device according to claim 14, wherein the value of the at least one frequency separation is greater than or equal to a first difference, and less than or equal to a second difference;
wherein the first difference is a difference between a minimum value of a downlink frequency configured by the network device and a maximum value of an uplink frequency configured by the network device, and the second difference is a difference between a maximum value of the downlink frequency configured by the network device and a minimum value of the uplink frequency configured by the network device.

17. The network device according to claim 13, wherein the processor is configured to execute the executable instructions to cause the network device to perform:
transmitting scheduling information to the terminal device, wherein the scheduling information is used to indicate an operating frequency scheduled based on the first capability information.

18. The network device according to claim 17, wherein the processor is configured to execute the executable instructions to cause the network device to further perform:
determining the operating frequency based on the first capability information;
determining the operating frequency based on the first capability information and channel quality;
determining the operating frequency based on the first capability information and a communication requirement of the network device; or
determining the operating frequency based on the first capability information, the channel quality, and the communication requirement of the network device,
wherein the channel quality is channel quality corresponding to a channel between the network device and the terminal device.

19. The network device according to claim 17, wherein the scheduling information is transmitted in the operating frequency.

20. The network device according to claim 13, wherein the first capability information is transmitted in an uplink frequency configured by the network device.
